(19) United States
(12) Patent Application Publication
(10) Pub. No.: US 2005/0221178 A1
(43) Pub. Date: Oct. 6, 2005

(54) Electrode package and secondary battery using the same

(76) Inventor: Yong-Sam Kim, Suwon-si (KR)

Correspondence Address: Robert E. Bushnell, Suite 300, 1522 K Street, N.W., Washington, DC, 20005-1202, US

(21) Appl. No.: 11/099,506

(22) Filed: Apr. 6, 2005

(30) Foreign Application Priority Data
Apr. 6, 2004 (KR) 10-2004-0023317

(51) Int. Cl. H01M 4/02; H01M 4/64

(52) U.S. Cl. 429/211; 429/161; 429/233

(57) ABSTRACT

The electrode package for a secondary battery with an electrode assembly including a positive electrode, a negative electrode, and a separator interposed between those two electrodes, each of the positive and negative electrodes having an uncoated region along the edge thereof, a positive collector plate covering the front end of the uncoated region of the positive electrode to be electrically connected to the uncoated region of the positive electrode, the positive collector plate having a portion disposed outside the electrode assembly, and a negative collector plate covering the front end of the uncoated region of the negative electrode to be electrically connected to the uncoated region of the negative electrode, the negative collector plate having a portion disposed outside the electrode assembly.

### CLAIM OF PRIORITY

This application makes reference to, incorporates the same herein, and claims all benefits accruing under 35 U.S.C. §119 from an application for ELECTRODES ASSEMBLY AND SECONDARY BATTERY USING THE SAME earlier filed in the Korean Intellectual Property Office on 6 Apr. 2004 and there duly assigned Serial No. 10-2004-0023317.

### BACKGROUND OF THE INVENTION

1. Technical Field

The present invention relates to a secondary battery and, more particularly, to an assembling structure of a collector plate and an electrode of an electrode package for a secondary battery.

2. Related Art

Unlike the primary battery, the secondary battery may be recharged. Common types of secondary batteries may be made into a battery pack and used as the power source for various portable electronic devices such as cellular phones, laptop computers, and camcorders.

Recently, a high power battery using the secondary battery has been developed to apply it as a power source for a motor of a hybrid electric vehicle (HEV).

Depending on the external shape, secondary batteries may be classified into different types, for example, square and cylindrical batteries. The square-shaped secondary battery has a structure that has a positive electrode and a negative electrode in the shape of a belt, and a separator interposed alternatively, a plurality of the positive and negative electrodes, stacked and wound into a square-shaped electrode assembly (as a form of a jellyroll), or plural positive and negative electrodes separated by a separator interposed therebetween are stacked into an electrode assembly; the electrode assembly is then inserted inside a square container.

In the electrode assembly with the wound positive and negative electrodes, leads are fixed to the positive and negative electrodes, respectively, to collect the current electrical generated between the positive and negative electrodes. The leads are connected to external terminals to conduct the electrical current flowing between the positive and negative electrodes.

Batteries with such a structure can achieve an adequate enough collection efficiency when used as small batteries to produce low battery capacity. When the battery is used for motor driven devices however, like HEVs which need large electrical current and high power, the collection method using the aforementioned leads decreases the collection efficiency; this method also has difficulty in uniformly collecting the current generated from every portion of the electrode assembly. Because the area of the positive and negative electrodes must be increased with any increase in the size of the battery, and accordingly, the resistance is increased.

In an effort to overcome these difficulties, efforts have been made to provide secondary batteries such as the battery disclosed in Japanese laid-open No. 6-267528, where lead attaching portions that are not coated with active materials are formed on one end of collectors for the positive and negative electrodes wound into of a belt shape. The lead attaching portions are disposed to protrude beyond the separator when the positive electrode, the negative electrode and the separator are wound to form the electrode assembly, and a plurality of the positive electrode leads and the negative electrode leads are respectively attached to the lead attaching portions.

This secondary battery, a plurality of leads can be fixed to the lead attaching portion, and the electrical current from the positive electrode and the negative electrode can be collected while the internal resistance of the battery is reduced, thereby increasing the collecting efficiency.

Since the above secondary battery needs to fix the plurality of leads to the lead attaching portions of the positive electrode and the negative electrode however, I have discovered that there is a problem this lowers the manufacturing efficiency. I also discovered that the size of portions which do not have active material and do not substantially participate in the battery reaction, that is, the size of portions of the lead attaching portions and plurality of leads inside the battery, has been increased, which makes it difficult to manufacture large capacity and high power batteries.

In the meantime, batteries with an electrode assembly formed by stack a plurality of positive and negative electrodes with an interposed separator, has a plurality of leads fixed to the positive electrode and the negative electrode. The leads fixed to the positive electrode are tied together and connected to an exterior terminal, and the leads fixed to the negative electrode are tied together and connected to an exterior terminal. I have noticed that since the secondary batteries with such a structure also needs to fix a plurality of leads to the positive electrode and the negative electrode, there is a problem that the number of the manufacturing steps increases and thereby the manufacturing efficiency is decreased.

### SUMMARY OF THE INVENTION

It is therefore, one object of the present invention to provide an improved electrode package and an improved secondary battery.

It is another object to provide an electrode package and secondary battery exhibiting an enhanced electrical capacity with uniform extraction of electrical current throughout the electrode assembly.

It is still another object to provide an electrode package and secondary battery exhibiting an enhanced electrical capacity with minimization of the size of those portions of the electrode assembly which are not coated with active materials.

In accordance with these and either objects, there is provided an electrode package and a secondary battery which can increase the collection efficiency to enhance the power characteristics, and can also uniformly extract the current generated from every portion of the electrode assembly.

Also, there is provided an electrode package and a secondary battery which enable the battery to have large size and high power by minimizing portions that do not have active material and do not substantially participate in the battery's reaction.

According to one aspect of the present invention, an electrode package for a secondary battery includes an electrode assembly including a positive electrode, a negative electrode, and a separator interposed between each pair of those two electrodes, each of the positive and negative electrodes having an uncoated region along an edge thereof, a positive collector plate covering the front end of the uncoated region of the positive electrode to be electrically connected to the uncoated region of the positive electrode, the positive collector plate having a portion extending beyond and outside the electrode assembly, and a negative collector plate covering the front end of the uncoated region of the negative electrode to be electrically connected to the uncoated region of the negative electrode, the negative collector plate having a portion extending beyond and outside the electrode assembly.

The uncoated region of the positive electrode and the uncoated region of the negative electrode are arranged to face each other, forming many folds, and the positive collector plate and the negative collector plate are being in close contact with and fixed to the entire surfaces of the front end respectively of the uncoated region of the positive electrode and the front end of the uncoated region of the negative electrode.

The uncoated region of the positive electrode and the uncoated region of the negative electrode are arranged to face each other, forming many folds, and the positive collector plate and the negative collector plate are in close contact contacted with and fixed to the front end of the uncoated region of the positive electrode and the front end of the uncoated region of the negative electrode, respectively, exposing portions of each of the front ends.

The electrode package meets the following formula:
a≦b
where “a” is the length of the uncoated region of the positive electrode and the uncoated region of the negative electrode disposed outside the separator, and “b” is the maximum width of the positive collector plate and the negative collector plate.

The positive collector plate and the negative collector plate are fixed to the uncoated region of the positive electrode and the uncoated region of the negative electrode, respectively, by welding; the welding may be laser welding.

The uncoated region of the positive electrode and the uncoated region of the negative electrode are arranged to form many folds, and the uncoated regions can be bent symmetrically with respect to the uncoated region disposed at the center.

According to another aspect of the present invention, a secondary battery may be constructed with an electrode package including an electrode assembly including a positive electrode, a negative electrode, and a separator interposed between each pair of those two electrodes. Each of the positive and negative electrodes has an uncoated region along the edge thereof, and a positive collector plate covering the front end of the uncoated region of the positive electrode to be electrically connected to the uncoated region of the positive electrode. The positive collector plate has a portion disposed outside the electrode assembly. The negative collector plate covers the front end of the uncoated region of the negative electrode which is to be electrically connected to the uncoated region of the negative electrode. The negative collector plate has a portion disposed outside the electrode assembly. A container has an internal volume adequate to receive the electrode package, and a cap assembly fixed to an opening of the container to seal the container. The cap assembly includes electrode terminals being electrically that are connected to different corresponding ones of the positive collector plate and the negative collector plate, and the electrode assembly is mounted within the container at predetermined angle between the direction of width and the direction of height of the container.

The direction of width of the electrode assembly and the direction of height of the container are arranged to be mutually perpendicular, and the positive collector plate and the negative collector plate are arranged along the direction of the height of the container.

The secondary battery may have a square shape.

The secondary battery may be used to electrically power a motor driven device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a secondary battery constructed according to an embodiment of the present invention;

FIG. 2 is an oblique view of an electrode package constructed according to a first embodiment of the present invention;

FIG. 3 is a plan view of the electrode package constructed according to the first embodiment of the present invention;

FIG. 4 is a side view of the electrode package constructed according to the first embodiment of the present invention;

FIG. 5 is illustrates the structure of the uncoated region assembled with the collector plate in the electrode package according to the first embodiment of the present invention;

FIG. 6 is an oblique view of the electrode assembly according to an embodiment of the present invention;

FIG. 7 illustrates the structure showing a modified uncoated region assembled with the collector plate in the electrode package according to the first embodiment of the present invention;

FIG. 8 illustrates a collector constructed plate according to a modified embodiment of the first embodiment of the present invention;

FIG. 9 illustrates a collector plate constructed according to a second embodiment of the present invention; and

FIG. 10 illustrates a collector plate constructed according to a modified embodiment of the second embodiment of the present invention.

### DETAILED DESCRIPTION OF THE INVENTION

Reference will now be made in detail to the embodiments of the present invention, examples of which are illustrated in the accompanying drawings. The embodiments are described below to explain the present invention by reference to several figures of the drawings.

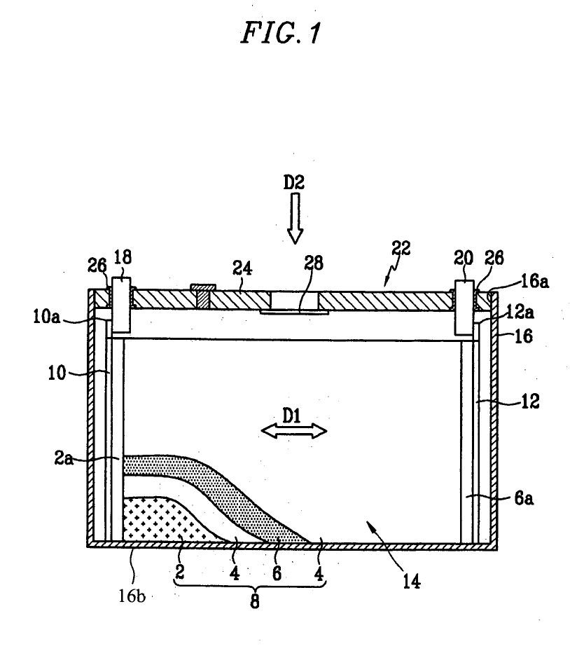

FIG. 1 is a cross-sectional view of a secondary battery constructed according to an embodiment of the present invention.

As shown in FIG. 1, the secondary battery includes an electrode package 14, a container 16 having an opening 16a formed on one of its sides to receive electrode package 14 inside the container, and a cap assembly 22 having a positive terminal 18 and a negative terminal 20 mounted in opening 16a to seal container 16. Electrode package 14 has an electrode assembly 8 formed by stacking and winding a positive plate 11, a negative plate 12 and a separator 13 of a belt shape, and a positive collector plate 10 and a negative collector plate 12 mounted on both ends of electrode assembly 8.

Container 16 is made of conductive metal such as aluminum, aluminum alloy, or steel plated with nickel, and its shape is hexahedron, or other polyhedron which has an inner space to receive electrode package 14. FIG. 1 shows that the electrode assembly of a rectangular or square shape is mounted inside a hexahedral shaped container 16.

Cap assembly 22 has a base plate 24 fixed to opening 16a by welding in order to seal container 16, and positive terminal 18 and negative terminal 20 fixed to extend completely through base plate 24 and respectively electrically connected to positive collector plate 10 and negative collector plate 12 of electrode package 16. When these two terminals 18, 20 are formed on base plate 24, an electrically insulating member 26 can be disposed in each region where terminals 18, 20 are formed. Safety vent 28 can be formed in the center of base plate 24 as a safety device. Safety vent 28 is configured to be broken to discharge gas from the interior of container 16 when internal pressure of the battery increases.

The direction D1 of the width of electrode assembly 8 is not coincident with the direction D2 of insertion of the electrode package 14 through opening 16a toward bottom 16b of container 16, that is, along the D2 of height direction of container 16, to form a predetermined angle between the width D1 and the height D2. It is preferable that electrode assembly 8 be disposed inside container 16 with the direction D1 of the width being perpendicular to the direction D2 of insertion, in order that the predetermined angle be ninety (90°) degrees.

Accordingly, positive collector plate 10 and negative collector plate 12 are arranged to lie parallel to the direction D2 of insertion, and the ends of positive collector plate 10 and negative collector 12 facing toward positive terminal 18 and negative terminal 20 are respectively fixed to positive terminal 18 and negative terminal 20, to receive electrically connections thereto.

The portions of positive collector plate 10 and negative collector plate 12 connected to positive terminal 18 and negative terminal 20 have corresponding extended lead portions 10a and 12a disposed outside of electrode assembly 8 when positive collector plate 10 and negative collector plate 12 are attached to electrode assembly 8.

Now, the structure of electrode package 14 for the secondary battery described in the foregoing paragraphs will be described in detail.

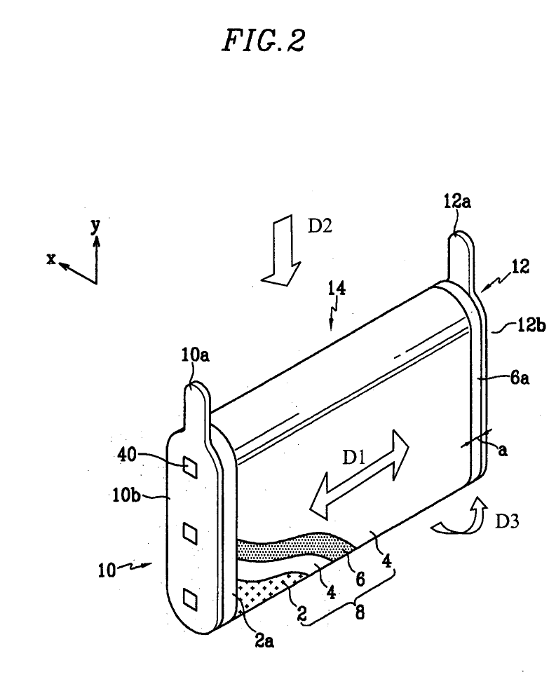

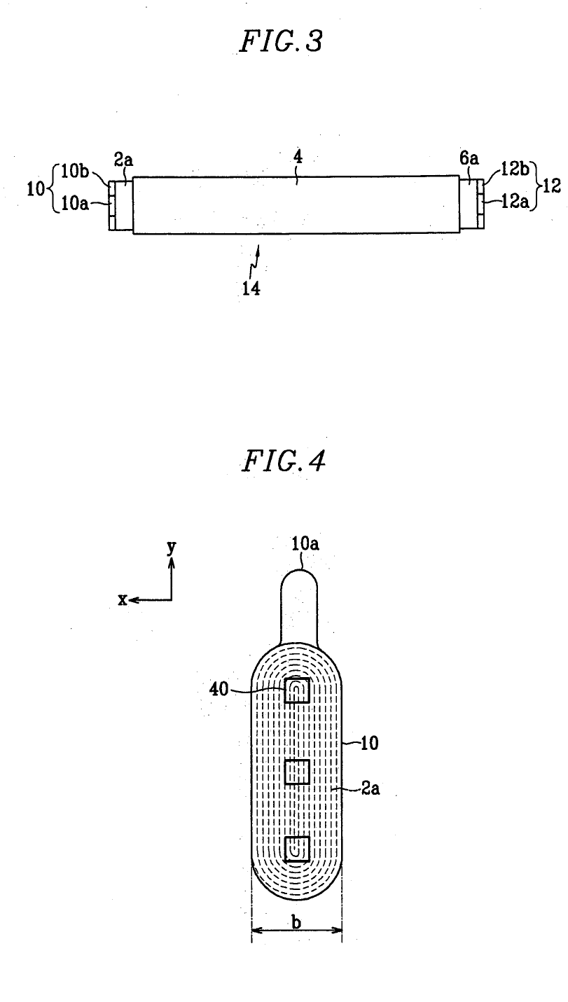

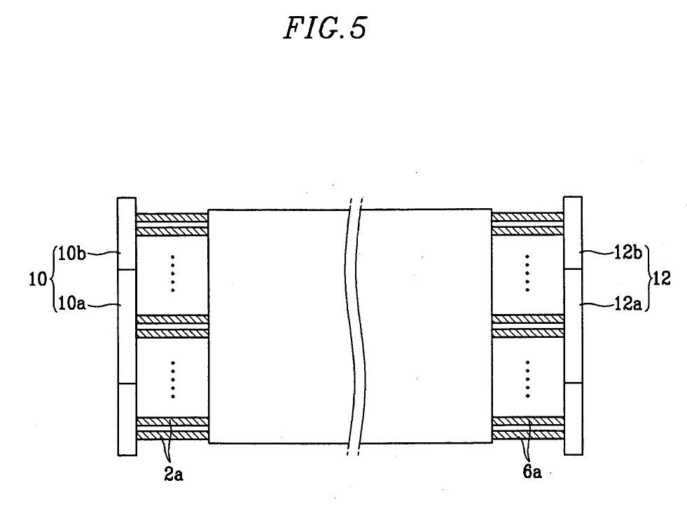

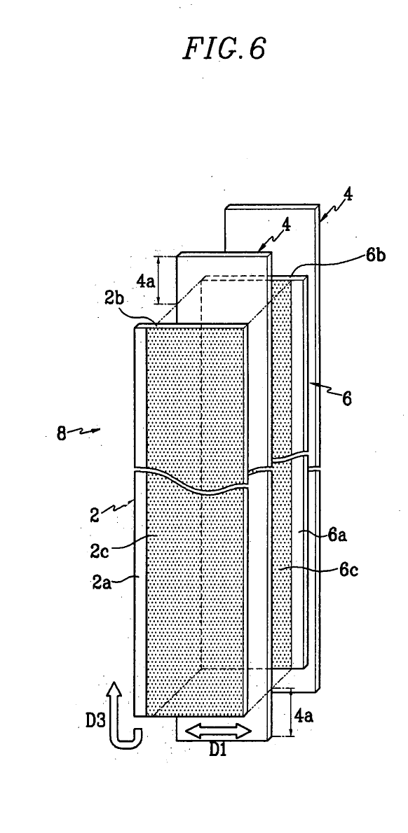

FIG. 2 and FIG. 3 are an oblique view and a plan view of the electrode package of FIG. 1, FIG. 4 is a left side view of the electrode package of FIG. 2, and FIG. 5 is a partial cross-sectional view of the electrode package of FIG. 2. FIG. 6 is an exploded oblique view illustrating an electrode assembly constructed according to the principles of the present invention.

Referring to the drawings collectively, electrode package 14 has electrode assembly 8 wound in a jellyroll configuration which is formed by stacking positive electrode 2, separator 4 and negative electrode 6 wound a belt shape, winding them along the direction D3 of the length as shown in FIG. 6, and pressing them.

When electrode assembly 8 is formed, uncoated regions 2a and 6a of positive electrode 2 and negative electrode 6 are facing each other. Uncoated regions 2a and 6a are portions of a collector 2b of positive electrode 2 and a collector 6b of negative electrode 6, which are uncoated with the active material along an edge of one end that is parallel with the direction D3 of length of collectors 2b and 6b when positive active material 2c and negative active material are coated on collectors 2b and 6b, respectively. When electrode assembly 8 is formed, these uncoated regions 2a and 6a are producing beyond separator 4 are disposed between positive electrode 2 and negative electrode 6.

The length of separator 4 is longer than the length of positive electrode 2 and negative electrode 6 to prevent a short-circuit from occurring between positive electrode 2 and negative electrode 6. Accordingly, separator 4 preferably has a spare portion 4a at its ends that does not overlap positive electrode 2 and negative electrode 6, when it is arranged between positive electrode 2 and negative electrode 2.

Positive collector plate 10 and negative collector plate 12 respectively cover the front ends of uncoated region 2a of the positive electrode and uncoated region 6a of the negative electrode, to provide electrical connection to the portion and negative poles of electrode assembly 8.

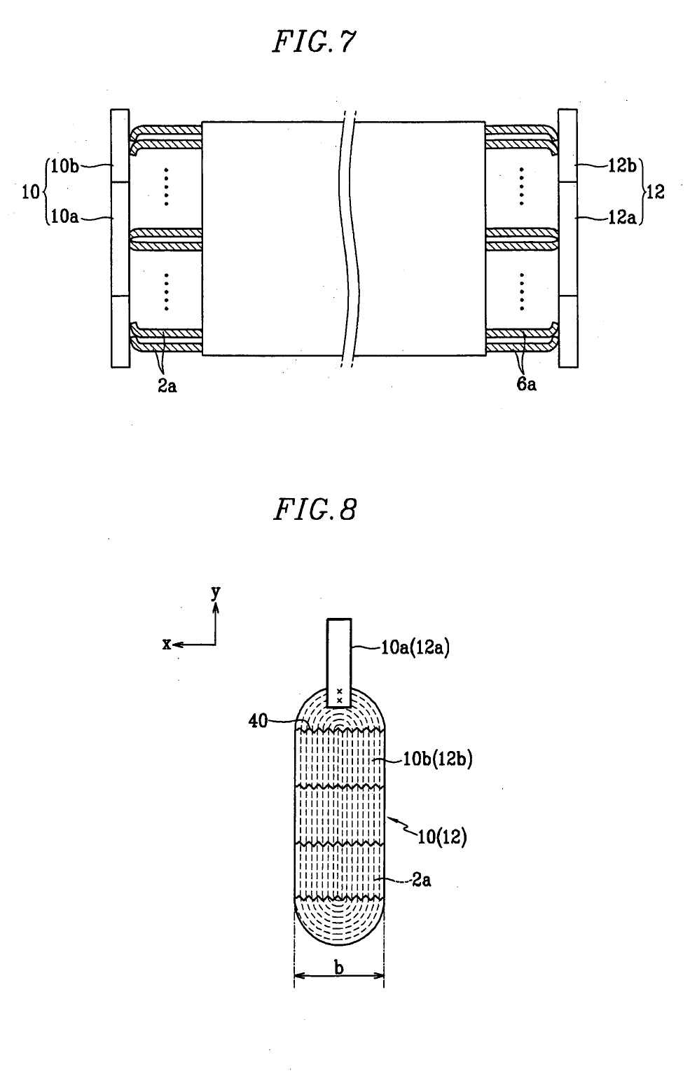

When collector plates 10 and 12 form an electrical contact with uncoated regions 2a and 6a, uncoated regions 2a and 6a may remain flat without bending as shown in FIG. 5, or may be regularly bent along one direction as shown in FIG. 7. In the case that uncoated regions 2a and 6a are bent, the area of contact between collector plates 10 and 12 and uncoated regions 2a and 6a will increase the aggregate electrical contact area with uncoated regions 2a and 6a to enhance the collection efficiency. FIG. 7 shows that uncoated regions 2a and 6a are bent toward the uncoated region disposed in the center of the electrode assembly 8.

Positive collector plate 10 and negative collector plate 12 of the present invention have cover portions 10b,12b mating with and entirely covering the corresponding uncoated regions 2a, 6a, and lead portions 10a, 12a extending from cover portions 10b, respectively 12b to form electrical connections with terminals 18, 20. This structure is given as one exemplary embodiment of the present invention however, and the principles of present invention are not limited to the above structure.

As shown in FIG. 4, lead portions 10a, 12a may be integrally formed with cover portions 10b, 12b. Alternatively, as shown in FIG. 8, lead portions 10a, 12a may be formed separately from cover portions 10b and 12b, and then fixed to them.

Collector plates 10 and 12 of the present embodiment are fixed to the corresponding uncoated regions 2a and 6a by laser welding, and, accordingly, a welded portion 40 is formed by laser welding on each of collector plates 10, 12. As shown in FIG. 8, welded portion 40 can have a liner shape across cover portions 10b, 12b.

Collector plates 10, 12 have a thickness (t) of between approximately 0.2 to approximately 0.3 mm, positive collector plate 10 may be made of aluminum, and negative collector plate 12 may be made of copper.

In a secondary battery of the present invention with the structure described in the foregoing paragraphs, positive collector plate 10 and negative collector plate 12 collect electrical current generated by the battery between positive electrode 2 and negative electrode within electrode package 14 and collector plates 10, 12 are respectively fixed to the front ends of positive uncoated region 2a and negative uncoated region 6a. This enables collector plates 10, 12 to be easily attached without decreasing the collection efficiency of the electrical current even if the lengths of positive uncoated region 2a and negative uncoated region 6a exposed outside separator 4 are not lengthened to the length necessary for attaching separate leads to the uncoated regions 2a, 6a.

In a secondary battery of the present invention, the size of a portion of a positive or negative electrode which does not have active material and not substantially participate in the battery reaction when electrode package 14 is mounted inside container 16, that is, the size of a portion which is used to form electrical connections between positive and negative uncoated regions 2a, 6a and the respective positive and negative collector plates 10, 12 inside container 16, can be decreased in comparison to a conventional battery.

Accordingly, in comparison with the conventional electrode package of the same size, the secondary battery of the present invention can increase the coated portion of active material distributed on positive and negative collectors 2b, 6b, which has an advantage of allowing the manufacture of larger size and higher power secondary batteries.

Conversely, in the case that the active material region coated on the collector has the same area as that of a conventional battery, even though the uncoated region is decreased, the current collection may not be affected due to the above mentioned fixation structure of the collector plate. Accordingly, the battery size may be reduced by as much as the reduction of the uncoated region so that the battery with a smaller size per unit capacity can be provided to consumers.

Moreover, in the secondary battery of the present invention, positive and negative collector plates 10, 12 cover the front ends of the corresponding uncoated regions 2a, 6a and are electrically connected to uncoated regions 2a, 6a, and thereby, the contact area is increased and the internal resistance caused by the contact area is minimized.

Accordingly, the secondary battery of the present invention can achieve a uniformly collection of the current from every portion of the collector and thereby increase its collection efficiency.

Furthermore, the secondary battery of the present invention directly connects some portions (that is, the lead portions mentioned above) of the positive and negative collector plates to positive terminal 18 and negative terminal 20, which can simplify structure required for the electrical connection of the electrode package with the positive and negative terminals.

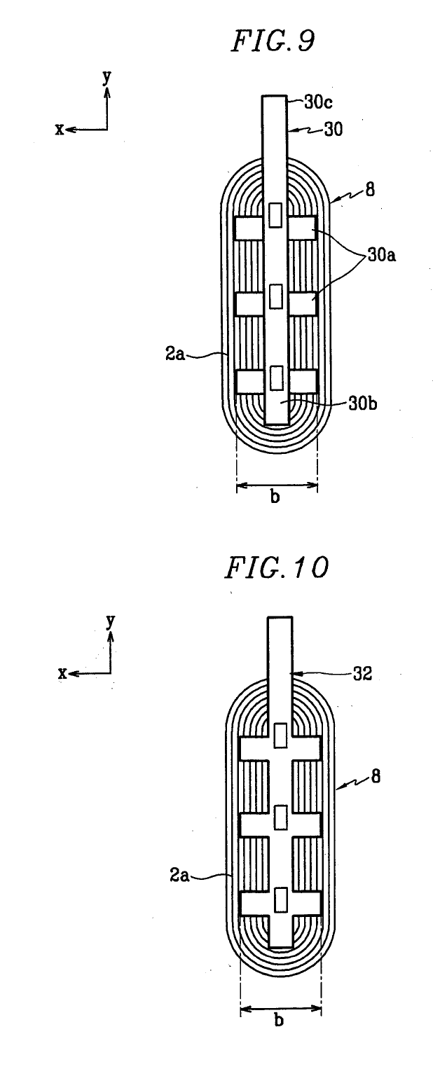

Referring now to FIG. 9, another embodiment of the present invention will be described below.

FIG. 9 is a side view of an electrode package seen from a positive electrode according to a secondary embodiment of the present invention.

With reference to FIG. 9, positive collector plate 30 of the secondary embodiment includes a plurality of a first collector plates 30a spaced apart from each other, and a plurarity of second collector plates 30b attached to and electrically connected to first collector plates 30a.

Positive collector plate 30 is fixed in close electrical contact with and fixed to the front end of positive uncoated region 2a by laser welding.

One end of second collector plate 30b is disposed outside electrode assembly 8 to form a lead portion 30c connecting to the terminal of the secondary battery. Secondary collector plate 30b is arranged to extend parallel with the direction D2 of insertion of electrode package 14 shown in FIG. 1 to permit assembly with first collector plate 30a.

Positive collector plate 30 of the second embodiment, unlike that of the first embodiment, does not entirely cover the front end of the uncoated region of the electrode, but is connected to the uncoated region while exposing at least some portion of the front end. Such a structure has an advantage in that the electrolyte can be easily impregnated into and throughout the electrode assembly 8 via the exposed portion, when the electrode package is mounted inside the container and the electrolyte is subsequently poured into container 16.

In the secondary embodiment, the negative collector plate can be formed in the same way as the positive collector plate is formed, the details of which need not be further described here.

FIG. 10 is a side view of an electrode package seen from a positive electrode like FIG. 9 according to a modified embodiment of the second embodiment of the present invention.

The overall shape of positive collector plate 32 according to the modified embodiment is the same as that of the positive collector plate of the secondary embodiment shown by FIG. 9, but first collector plates 32a and second collector plate 32b are integrated into a single structure and are not separated.

Such a positive collector plate 32 has advantages not only in impregnating the electrolyte as does the secondary embodiment, but also in increasing the manufacturing efficiency for fixing positive collector plate 32 to positive uncoated region 2a. Collector plates 32 may be made from a single sheet of an electrically conducting material.

In the modified embodiment, the negative collector plate can also be formed in the same way as the positive collector plate is formed, the details of which need not be further described here.

The following paragraphs will describe the shape condition of electrode package 14 which allows the secondary battery with collector plates 10, 12, 30 and 32 mentioned above, to facilitate the attachment of the positive and negative collector plates as well as to increase the amount of the active material carried by electrode assembly 8.

Collector plates 10, 12, 30 and 32 have a rectangular shape with a width direction “x” a length direction “y” as is represented by the orthogonal coordinates shown in the drawings. The electrode package can be set to meet the following formula:
a≦b
where “a” is the length of uncoated regions 2a and 6a of the positive and negative electrodes exposed outside separator 4 (See FIG. 2), and “b” is the maximum widths of collector plates 10, 12, 30 and 32 (See FIG. 4, FIG. 8, FIG. 9, and FIG. 10).

For electrode package 14 where “a” is longer than “b”, either the lengths of uncoated regions 2a and 6a of the positive and negative electrodes exposed outside separator 4 become too long, or the maximum widths of collector plates 10, 12, 30 and 32 become too short. This makes it difficult to increase the amount of the active material borne by electrode assembly 8, and to achieve high collection efficiency due to the decrease of the contact area between collector plates 10, 12, 30 and 32 and uncoated regions 2a and 6a of the positive and negative electrodes.

It is preferable that “a” be between approximately 1 to approximately 8 mm. If “a” is less than approximately 1 mm, the manufacturing efficiency is decreased when collector plates 10, 12, 30 and 32 are fixed to electrode assembly 8 by welding. If it is more than 8 mm, the coated area of the active material of electrode assembly 8 is decreased with a resulting decrease of the energy density per volume.

The secondary battery of the present invention can be used as the power source for motor driving devices such as hybrid electric vehicles, electric vehicles, wireless vacuum cleaners, motorbikes, or motor scooters.

The secondary battery of the present invention can minimize its internal resistance, increase the collection efficiency of the positive and negative electrodes, and uniformly extract electrical current from every portion of the electrode assembly. Accordingly, it has an advantage in manufacturing high power batteries.

Although a few embodiments of the present invention have been shown and described, it would be appreciated by those skilled in the art that changes may be made in this embodiment without departing from the principles and spirit of the invention, the scope of which is defined in the claims and their equivalents.

1. An electrode package for a secondary battery, comprising:
an electrode assembly including a positive electrode, a negative electrode, and a separator interposed between those two electrodes, each of the positive and negative electrodes having an uncoated region along edges thereof;
a positive collector plate covering a front end of the uncoated region of the positive electrode disposed to be electrically connected to the uncoated region of the positive electrode, the positive collector plate having a portion extending beyond the electrode assembly; and
a negative collector plate covering a front end of the uncoated region of the negative electrode disposed to be electrically connected to the uncoated region of the negative electrode, the negative collector plate having a portion extending beyond the electrode assembly.

2. The electrode package for a secondary battery of claim 1, wherein the uncoated region of the positive electrode and the uncoated region of the negative electrode are arranged to face each other, forming a plurality of folds, and the positive collector plate and the negative collector plate are respectively in close contact with and fixed to entire surfaces of the front end of the uncoated region of the positive electrode and the front end of the uncoated region of the negative electrode.

3. The electrode package for a secondary battery of claim 1, wherein the uncoated region of the positive electrode and the uncoated region of the negative electrode are arranged to face each other, forming many folds, and the positive collector plate and the negative collector plate are respectively in close contact with and fixed to the front end of the uncoated region of the positive electrode and the front end of the uncoated region of the negative electrode, exposing portions of each of the front ends.

4. The electrode package for a secondary battery of claim 1, wherein the electrode package meets the following formula:
a≦b
where “a” is the length of the uncoated region of the positive electrode and the uncoated region of the negative electrode disposed outside the separator, and “b” is the maximum width of the positive collector plate and the negative collector plate.

5. The electrode package for a secondary battery of claim 1, wherein the length of the uncoated region of the positive electrode and the length of the uncoated region of the negative electrode disposed outside the separator within a range of between approximately 1 to approximately 8 mm.

6. The electrode package for a secondary battery of claim 1, wherein the positive collector plate and the negative collector plate are respectively fixed to the uncoated region of the positive electrode and the uncoated region of the negative electrode, by welding.

7. The electrode package for a secondary battery of claim 6, wherein the welding is performed by laser welding.

8. The electrode package for a secondary battery of claim 1, wherein the thickness of the positive collector plate and the negative collector plate is within a range of between 0.2 to approximately 0.3 mm.

9. The electrode package for a secondary battery of claim 1, wherein the uncoated region of the positive electrode and the uncoated region of the negative electrode are arranged to form many folds, and the uncoated regions are bent symmetrically with respect to the uncoated region toward in a center of the electrode package.

10. A secondary battery, comprising:
an electrode package including an electrode assembly comprised of:
a positive electrode, a negative electrode, and a separator interposed between those two electrodes, each of the positive and negative electrodes having an uncoated region along edges thereof;
a positive collector plate covering a front end of the uncoated region of the positive electrode to be electrically connected to the uncoated region of the positive electrode, the positive collector plate having a portion extending beyond the electrode assembly; and
a negative collector plate covering the front end of a uncoated region of the negative electrode to be electrically connected to the uncoated region of the negative electrode, the negative collector plate having a portion extending beyond the electrode assembly;
a container having an interior to receive the electrode package; and
a cap assembly fixed across an opening of the container to seal the container, the cap assembly including electrode terminals electrically connected to corresponding ones of the positive collector plate and the negative collector plate;
wherein the electrode assembly is mounted within the container to make a predetermined angle between a direction of width of the electrode package and the direction of height of the container.

11. The secondary battery of claim 10, wherein the direction of width of the electrode assembly and the direction of height of the container are arranged to be perpendicular, and the positive collector plate and the negative collector plate are arranged along the direction of height.

12. The secondary battery of claim 10, wherein the uncoated region of the positive electrode and the uncoated region of the negative electrode are arranged to face each other, forming a plurality of folds, and the positive collector plate and the negative collector plate are respectively in close contact with and fixed to entire surfaces of the front end of the uncoated region of the positive electrode and the front end of the uncoated region of the negative electrode.

13. The secondary battery of claim 10, wherein the uncoated region of the positive electrode and the uncoated region of the negative electrode are arranged to face each other, forming many folds, and the positive collector plate and the negative collector plate are respectively in close contact with and fixed to the front end of the uncoated region of the positive electrode and the front end of the uncoated region of the negative electrode, exposing portions of each of the front ends.

14. The secondary battery of claim 10, wherein the secondary battery meets the following formula:
a≦b
where “a” is the length of the uncoated region of the positive electrode and the uncoated region of the negative electrode disposed outside the separator, and “b” is the maximum width of the positive collector plate and the negative collector plate.

15. The secondary battery of claim 10, wherein the positive collector plate and the negative collector plate are attached to the uncoated region of the positive electrode and the uncoated region of the negative electrode, respectively, by welding.

16. The secondary battery of claim 15, wherein the welding is by laser welding.

17. The secondary battery of claim 10, wherein the secondary battery has a square shape.

18. The secondary battery of claim 10, wherein the secondary battery is for a motor driven device.

19. A secondary battery, comprising:
an electrode package, comprised of:
a positive electrode exhibiting an uncoated edge,
a negative electrode exhibiting an uncoated edge,
a separator interposed between the positive electrode and the negative electrode,
a positive collector plate electrically connected at a first end of the electrode package to a plurality of locations on the uncoated edge of the positive electrode, and
a negative collector plate separated from the positive collector plate by a first width, and electrically connected at a second end of the electrode package to a plurality of locations on the uncoated edge of the negative,
terminal portions of the positive collector plate and the negative collector plate both extending in a single direction beyond the positive electrode and the negative electrode, and;
a container exhibiting an opening disposed to receive the electrode package into an interior having a second width coextensive with and greater than the first width; and
a cap assembly sealing the container by closing the opening.

20. The secondary battery of claim 19, comprised of:
the uncoated edge of the positive electrode being positioned on the first end, and
the uncoated edge of the negative electrode being positioned on the second end.
